(19) United States
(12) Patent Application Publication
(10) Pub. No.: US 2021/0341147 A1
(43) Pub. Date: Nov. 4, 2021

(54) Gas Turbine Combustor

(71) Applicant: Mitsubishi Power, Ltd., Yokohama-shi (JP)

(72) Inventors: Yasuhiro WADA, Yokohama (JP); Tetsuma TATSUMI, Yokohama (JP); Kazuki ABE, Tokyo (JP); Keita YUNOKI, Tokyo (JP); Akinori HAYASHI, Yokohama (JP)

(21) Appl. No.: 17/244,275

(22) Filed: Apr. 29, 2021

(30) Foreign Application Priority Data
May 1, 2020 (JP) 2020-081062

(51) Int. Cl. F23R 3/28; F02C 7/22

(52) U.S. Cl. CPC F23R 3/28; F05D 2240/35; F05D 2220/32; F02C 7/22

(57) ABSTRACT

A gas turbine combustor is capable of uniformizing a distribution of fuel concentrations to reduce NOx emissions. The gas turbine combustor includes a main burner of the premixed combustion type and a combustion chamber for burning a fuel and air supplied from the main burner. The main burner includes a fuel nozzle for injecting a fuel supplied from a main fuel system and a premixture passageway for mixing the fuel injected from the fuel nozzle and air supplied from an air passageway and supplying the air-fuel mixture to the combustion chamber. The fuel nozzle includes a tapered portion, a flat portion extending from the tapered portion toward a distal side thereof, a fuel passageway defined in the fuel nozzle, and first and second arrays of fuel injection holes providing fluid communication between the fuel passageway and the outside of the fuel nozzle. The first array of fuel injection holes is defined in the tapered portion.

### BACKGROUND OF THE INVENTION

### 1. Field of the Invention

The present invention relates to a gas turbine combustor.

### 2. Description of the Related Art

A gas turbine combustor disclosed in JP-2013-245900-A referred to below includes a pilot burner, a main burner disposed on an outer circumferential side of the pilot burner, and a combustion chamber for burning a fuel and air supplied from the pilot burner and the main burner. The pilot burner is of the diffusive combustion type and injects the fuel directly into the combustion chamber.

The main burner is of the premixed combustion type and includes a fuel nozzle for injecting the fuel supplied from a fuel system and a premixture passageway for mixing the fuel injected from the fuel nozzle and air supplied from an air passageway with each other and supplying the air-fuel mixture to the combustion chamber. Therefore, the main burner mixes the fuel and the air in the premixture passageway and supplies the air-fuel mixture to the combustion chamber. The premixed combustion reduces NOx emissions compared with the diffusive combustion.

The fuel nozzle of the main burner has a fuel passageway defined therein that extends in an axial direction of the fuel nozzle, and first and second arrays of fuel injection holes defined in the fuel nozzle so as to provide fluid communication between the fuel passageway and the outside of the fuel nozzle.

The first array of fuel injection holes and the second array of fuel injection holes are spaced from each other in the axial direction of the fuel nozzle. The fuel injection holes of the first array are four fuel injection holes disposed at equal intervals in the circumferential directions of the fuel nozzle, for example. The fuel injection holes of the second array are four fuel injection holes disposed at equal intervals in the circumferential directions of the fuel nozzle, for example. The first array of fuel injection holes and the second array of fuel injection holes inject streams of fuel along respective directions that are angularly spaced 45 degrees from each other, or stated otherwise, extend at respective angles that are angularly spaced 45 degrees from each other in a cross-sectional plane across the fuel nozzle. This layout of the first and second array of fuel injection holes provides diffused or distributed positions for injecting the fuel in the axial and circumferential directions of the fuel nozzle.

[Patent Document]

[Patent Document 1] JP-2013-245900-A

However, the related art referred to above still remains to be improved. According to JP-2013-245900-A, the first and second array of fuel injection holes are disposed in a flat portion of the fuel nozzle, or specifically a portion of the fuel nozzle which has the same outside diameter from proximal to distal ends of the fuel nozzle. An air stream flowing along the flat portion of the fuel nozzle flows axially of the fuel nozzle, and has almost no stream component in a radial direction of the fuel nozzle. The air stream flowing along the flat portion of the fuel nozzle does not promote mixing of the fuel injected from the fuel injection holes with the air in the radial direction of the fuel nozzle. Consequently, the related art still needs to be improved about uniformization of a distribution of fuel concentrations to reduce NOx emissions.

It is an object of the present invention to provide a gas turbine combustor that is capable of uniformizing a distribution of fuel concentrations to reduce NOx emissions.

### SUMMARY OF THE INVENTION

According to the present invention, there is provided a gas turbine combustor including a premixture combustion burner and a combustion chamber for burning a fuel and air supplied from the premixture combustion burner, the premixture combustion burner including a fuel nozzle for injecting a fuel supplied from a fuel system and a premixture passageway for mixing the fuel injected from the fuel nozzle and air supplied from an air passageway and supplying an air-fuel mixture to the combustion chamber, in which the fuel nozzle includes a tapered portion whose outside diameter is progressively reduced from a proximal side to a distal side of the fuel nozzle, a flat portion extending from the tapered portion toward the distal side of the fuel nozzle and having a uniform outside diameter from a proximal side to the distal side of the fuel nozzle, a fuel passageway defined in the fuel nozzle and extending in an axial direction of the fuel nozzle, and a plurality of arrays of fuel injection holes defined in the fuel nozzle to provide fluid communication between the fuel passageway and an outside of the fuel nozzle, each array including at least one fuel injection hole, the arrays being spaced from each other in the axial direction of the fuel nozzle, and the arrays of fuel injection holes include at least one array of fuel injection holes defined in the tapered portion.

According to the present invention, NOx emissions can be reduced.

The above and other objects, features, and advantages of the present invention will become more obvious from the detailed description given below when taken together with the accompanying drawings.

### BRIEF DESCRIPTION OF THE DRAWINGS

FIG. 1 is a schematic view illustrating the structure of a gas turbine combustor according to a first embodiment of the present invention and the structure of a gas turbine that incorporates the gas turbine combustor;

FIG. 2 is an enlarged view of an encircled portion II of FIG. 1, illustrating the structure of a fuel nozzle of a main burner;

FIGS. 3A and 3B are cross-sectional views taken along respective lines A and B of FIG. 2, illustrating layouts of fuel injection holes;

FIG. 4 is an enlarged view illustrating the structure of a fuel nozzle of a main burner according to a comparative example, and an air stream and a fuel stream in a premixture passageway;

FIG. 5 is an enlarged view illustrating the structure of a fuel nozzle of a main burner according to the first embodiment of the present invention, and an air stream and a fuel stream in a premixture passageway;

FIGS. 6A and 6B are cross-sectional views illustrating layouts of fuel injection holes according to a first modification of the present invention;

FIGS. 7A and 7B are cross-sectional views illustrating layouts of fuel injection holes according to a second modification of the present invention;

FIG. 8 is an enlarged view illustrating the structure of a fuel nozzle of a main burner according to a second embodiment of the present invention;

FIGS. 9A, 9B, and 9C are cross-sectional views taken along respective lines A, B, and C of FIG. 8, illustrating layouts of fuel injection holes;

FIG. 10 is an enlarged view illustrating the structure of a fuel nozzle of a main burner according to the second embodiment of the present invention, and an air stream and a fuel stream in a premixture passageway;

FIGS. 11A, 11B, and 11C are cross-sectional views illustrating layouts of fuel injection holes according to a third modification of the present invention;

FIG. 12 is an enlarged view illustrating the structure of a fuel nozzle of a main burner according to a fourth modification of the present invention; and

FIGS. 13A and 13B are cross-sectional views taken along respective lines A and B of FIG. 12, illustrating layouts of fuel injection holes.

### DESCRIPTION OF THE PREFERRED EMBODIMENTS

### First Embodiment

A gas turbine combustor according to a first embodiment of the present invention will be described below with reference to the figures.

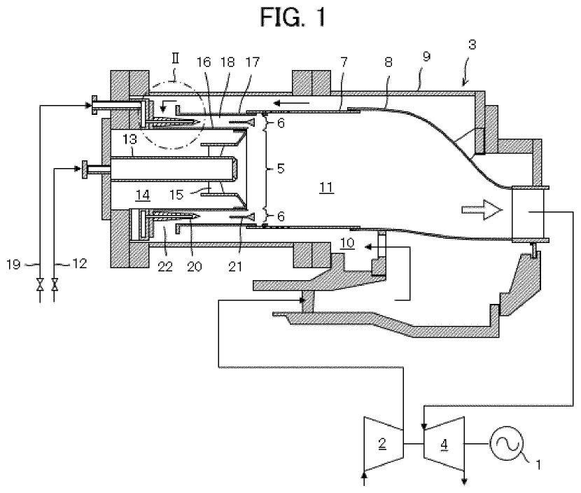

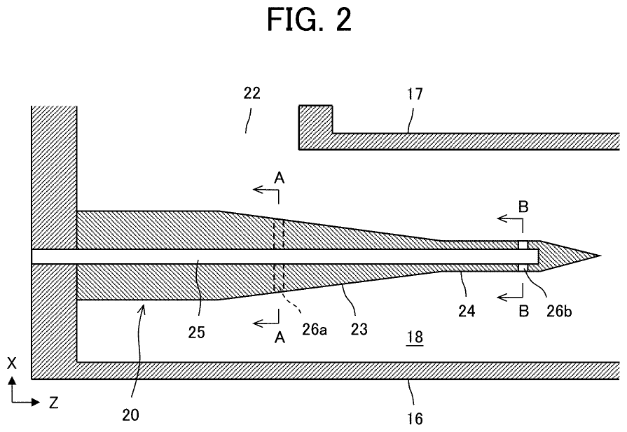

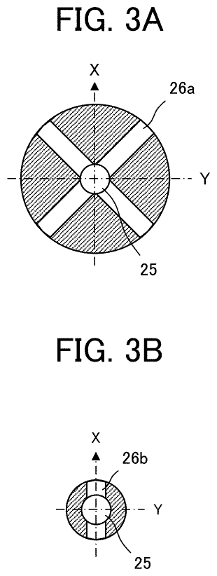

FIG. 1 schematically illustrates the structure of a gas turbine combustor according to the first embodiment and the structure of a gas turbine that incorporates the gas turbine combustor. FIG. 2 is an enlarged view of an encircled portion II of FIG. 1, illustrating the structure of a fuel nozzle of a main burner, and FIGS. 3A and 3B are cross-sectional views taken along respective lines A and B of FIG. 2, illustrating layouts of fuel injection holes.

As illustrated in FIG. 1, a gas turbine plant according to the present embodiment includes an electric generator 1 and a gas turbine for driving the electric generator 1. The gas turbine includes a compressor 2 for producing high-pressure air, a combustor 3 for burning a fuel with high-pressure air supplied from the compressor 2, and a turbine 4 driven by combustion gases from the combustor 3. The electric generator 1 and the compressor 2 are connected coaxially to the turbine 4 and driven by the turbine 4.

The combustor 3, i.e., a gas turbine combustor, includes a pilot burner 5, a main burner 6 disposed on an outer circumferential side of the pilot burner 5, a hollow cylindrical liner 7 disposed downstream, i.e., on the right side in FIG. 1, of the pilot burner 5 and the main burner 6, and a transition piece 8 connected to a downstream side of the liner 7. An air passageway 10 for supplying the high-pressure air from the compressor 2 to the pilot burner 5 and the main burner 6 is defined outside of the liner 7 and the transition piece 8, i.e., between the liner 7 and a casing 9 and between the transition piece 8 and the casing 9.

A combustion chamber 11 is defined in the liner 7. In the combustion chamber 11, the fuel and air supplied from the pilot burner 5 and the main burner 6 are burned, producing combustion gases. The combustion gases produced in the combustion chamber 11 are supplied through the transition piece 8 to the turbine 4.

The pilot burner 5 is of the diffusive combustion type and includes a fuel nozzle 13 for injecting the fuel supplied from a pilot fuel system 12, an air passageway 14 defined on an outer circumferential side of the fuel nozzle 13, and a plurality of swirling vanes 15 for producing a swirling flow in the air passageway 14. The air passageway 14 is held in fluid communication with the air passageway 10. The pilot burner 5 injects the fuel from the fuel nozzle 13 into the combustion chamber 11 and supplies air from the air passageway 14 to the combustion chamber 11.

The main burner 6 is of the premixed combustion type and includes an inner circumferential partition member 16 shaped as a hollow cylindrical member disposed on an outer circumferential side of the pilot burner 5, an outer circumferential partition member 17 shaped as a hollow cylindrical member disposed on an outer circumferential side of the inner circumferential partition member 16, a premixture passageway 18 defined between the inner circumferential partition member 16 and the outer circumferential partition member 17, a plurality of fuel nozzles 20 for injecting a fuel supplied from a main fuel system 19 into the premixture passageway 18, and an annular flame stabilizer 21 disposed downstream of the premixture passageway 18. The premixture passageway 18 mixes the fuel injected from the fuel nozzles 20 and the air supplied from the air passageway 10 through an opening 22 defined in the outer circumferential partition member 17 and supplies the air-fuel mixture to the combustion chamber 11.

As illustrated in FIG. 2, each of the fuel nozzles 20 includes a tapered portion 23 whose outside diameter is progressively reduced from a proximal side thereof, i.e., a left-hand side in FIG. 2, toward a distal side thereof, i.e., a right-hand side in FIG. 2, a flat portion 24 whose outside diameter remains constant from a proximal side thereof toward a distal side thereof and which is disposed on the distal side relative to the tapered portion 23, a fuel passageway 25 defined in the fuel nozzle 20 and extending in an axial direction Z of the fuel nozzle 20, and a first array of fuel injection holes 26a and a second array of fuel injection holes 26b that are defined in the fuel nozzle 20 so as to provide fluid communication between the fuel passageway 25 and the outside of the fuel nozzle 20.

The first array of fuel injection holes 26a and the second array of fuel injection holes 26b are spaced from each other in the axial direction Z of the fuel nozzle 20. The first array of fuel injection holes 26a is positioned upstream of the second array of fuel injection holes 26b with respect to the direction in which the fuel or the air flows. Stated otherwise, the second array of fuel injection holes 26b is positioned downstream of the first array of fuel injection holes 26a with respect to the direction in which the fuel or the air flows.

As illustrated in FIG. 3A, the fuel injection holes 26a of the first array are four fuel injection holes 26a disposed at equal intervals in the circumferential directions of the fuel nozzle 20. The four fuel injection holes 26a are disposed in a cross-sectional plane across the fuel nozzle 20 at respective angles of 45, 135, 225, and 315 degrees that are incremented clockwise around the fuel passageway 25 from a radial direction X of the premixture passageway 18. As illustrated in FIG. 3B, the fuel injection holes 26b of the second array are two fuel injection holes 26b disposed at equal intervals in the circumferential directions of the fuel nozzle 20. The two fuel injection holes 26b are disposed in a cross-sectional plane across the fuel nozzle 20 at respective angles of 0 and 180 degrees around the fuel passageway 25 from the radial direction X of the premixture passageway 18. In other words, the angles at which the fuel injection holes 26a of the first array are disposed around the fuel passageway 25 and the angles at which the fuel injection holes 26b of the second array are disposed around the fuel passageway 25 are shifted out of alignment with each other.

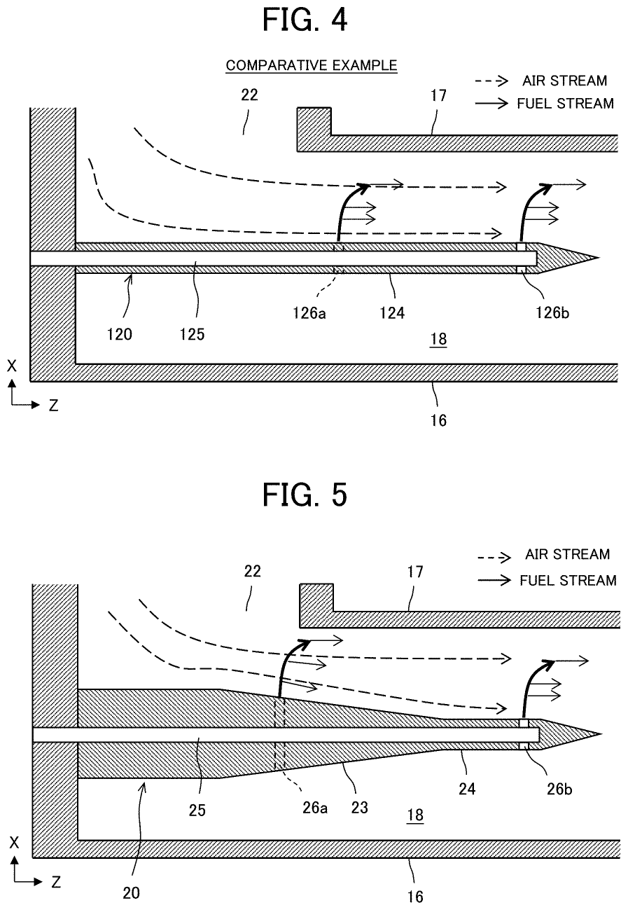

As illustrated in FIG. 2, the fuel injection holes 26b of the second array are defined in the flat portion 24 of the fuel nozzle 20. According to the most important feature of the present embodiment, the fuel injection holes 26a of the first array are defined in the tapered portion 23 of the fuel nozzle 20 and lie in the same position as the opening 22 in the outer circumferential partition member 17 along the axial direction Z of the premixture passageway 18. The effects will be described below with reference to FIGS. 4 and 5.

FIG. 4 illustrates the structure of a fuel nozzle of a main burner according to a comparative example, and an air stream and a fuel stream in a premixture passageway. FIG. 5 illustrates the structure of the fuel nozzle 20 of the main burner 6 according to the present embodiment, and an air stream and a fuel stream in the premixture passageway 18.

The fuel nozzle, denoted by 120, according to the comparative example has a flat portion 124, but is free of a tapered portion extending from the flat portion 124 toward a proximal side thereof. The fuel nozzle 120 has a fuel passageway 125 defined in the fuel nozzle 120 and extending in an axial direction Z of the fuel nozzle 120, and a first array of fuel injection holes 126a and a second array of fuel injection holes 126b that are defined in the fuel nozzle 120 so as to provide fluid communication between the fuel passageway 125 and the outside of the fuel nozzle 120. The fuel injection holes 126a of the first array and the fuel injection holes 126b of the second array are defined in the flat portion 124 of the fuel nozzle 120.

As illustrated in FIG. 4, an air stream flowing along the flat portion 124 of the fuel nozzle 120 are oriented in the axial direction Z of the fuel nozzle 120, and has almost no stream component in a radial direction X of the fuel nozzle 120. This air stream does not promote mixing of the fuel injected from the fuel injection holes 126a and 126b with the air in the radial direction X of the fuel nozzle 120.

In contrast, as illustrated in FIG. 5, an air stream flowing along the tapered portion 23 of the fuel nozzle 20 according to the present embodiment has a stream component in the radial direction X of the fuel nozzle 20. This air stream promotes mixing of the fuel injected from the fuel injection hole 126a of the first array with the air in the radial direction X of the fuel nozzle 20. Therefore, the fuel nozzle 20 is capable of uniformizing a distribution of fuel concentrations to reduce NOx emissions.

Further, the fuel injection holes 26a of the first array and the fuel injection holes 26b of the second array inject the fuel at respective different positions from the fuel nozzle 20 in the radial direction X. Consequently, the positions at which the fuel is injected from the fuel nozzle 20 are distributed or dispersed not only in the axial and circumferential directions of the fuel nozzle 20, but also in the radial direction of the fuel nozzle 20. The distributed or dispersed positions where the fuel is injected from the fuel nozzle 20 are also effective to promote mixing of the fuel with the air. Therefore, the fuel nozzle 20 is further capable of uniformizing a distribution of fuel concentrations to reduce NOx emissions. In addition, the fuel nozzle 20 is able to prevent internal flame stabilization and flame backflow that tend to occur in the presence of regions where a high fuel concentration prevails in the premixture passageway 18. Stated otherwise, the local air-fuel ratio up to the combustion chamber 11 is reduced to increase flashback resistance.

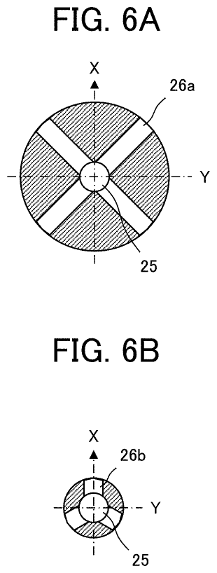

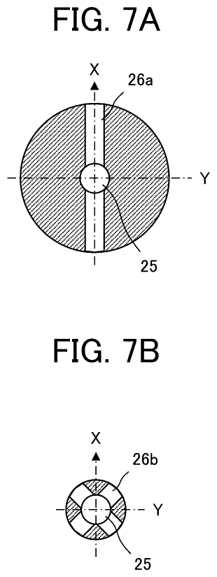

According to the first embodiment, the fuel injection holes 26a of the first array are four fuel injection holes 26a, whereas the fuel injection holes 26b of the second array are two fuel injection holes 26b. However, the present invention is not limited to the first embodiment as to the numbers of fuel injection holes of first and second arrays. According to a first modification of the present invention as illustrated in FIGS. 6A and 6B corresponding to FIGS. 3A and 3B, for example, the fuel injection holes 26b of the second array are three fuel injection holes 26b disposed at equal intervals in the circumferential directions of the fuel nozzle 20. As illustrated in FIG. 6B, the three fuel injection holes 26b of the second array are disposed in a cross-sectional plane across the fuel nozzle 20 at respective angles of 0, 120, and 240 degrees around the fuel passageway 25 from the radial direction X of the premixture passageway 18. According to a second modification of the present invention as illustrated in FIGS. 7A and 7B corresponding to FIGS. 3A and 3B, for example, the fuel injection holes 26a of the first array are two fuel injection holes 26a disposed at equal intervals in the circumferential directions of the fuel nozzle 20. As illustrated in FIG. 7A, the two fuel injection holes 26a are disposed in a cross-sectional plane across the fuel nozzle 20 at respective angles of 0 and 180 degrees around the fuel passageway 25 from the radial direction X of the premixture passageway 18. The fuel injection holes 26b of the second array are four fuel injection holes 26b disposed at equal intervals in the circumferential directions of the fuel nozzle 20. As illustrated in FIG. 7B, the four fuel injection holes 26b are disposed in a cross-sectional plane across the fuel nozzle 20 at respective angles of 45, 135, 225, and 315 degrees around the fuel passageway 25 from the radial direction X of the premixture passageway 18.

According to the first modification, the three fuel injection holes 26b of the second array, i.e., the final array, are asymmetrical with respect to a reference line Y passing through the radial center of the fuel nozzle 20 perpendicularly to the radial direction X of the premixture passageway 18. The three fuel injection holes 26b thus arranged are capable of dealing with a nonuniform concentration distribution, brought about by air streams, of the fuel ejected from the fuel injection holes 26a of the first array. Specifically, the different numbers of the fuel injection holes 26b on the radially outer and inner sides of the premixture passageway 18 are effective to uniformize a distribution of fuel concentrations.

### Second Embodiment

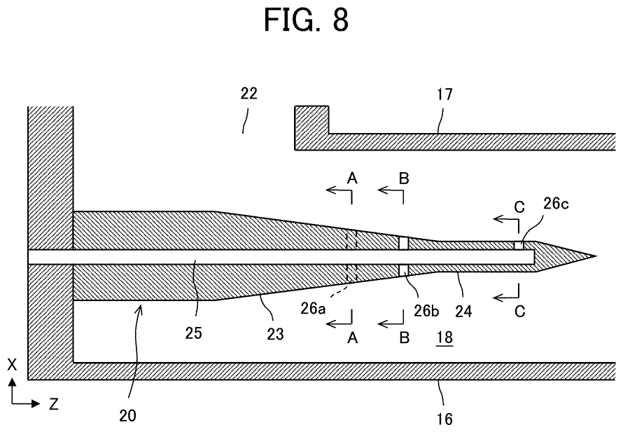

A gas turbine combustor according to a second embodiment of the present invention will be described below with reference to FIGS. 8 through 10. Note that portions in the present embodiment that are equivalent to their counterparts in the first embodiment are given the same reference characters, and explanation thereof is omitted as appropriate.

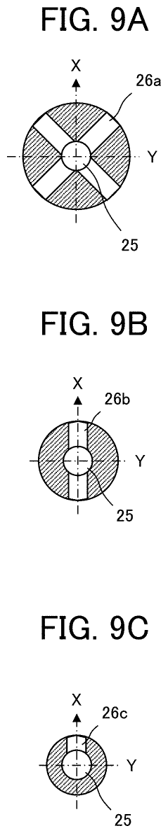

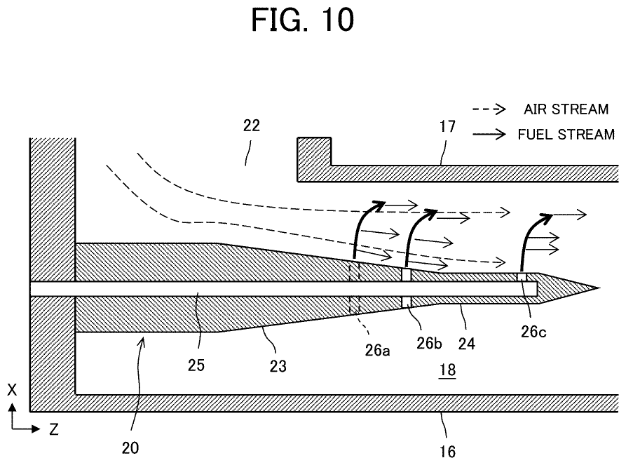

FIG. 8 illustrates the structure of a fuel nozzle of a main burner according to the present embodiment. FIGS. 9A, 9B, and 9C are cross-sectional views taken along respective lines A, B, and C of FIG. 8, illustrating layouts of fuel injection holes. FIG. 10 illustrates the structure of the fuel nozzle of the main burner according to the present embodiment, and an air stream and a fuel stream in a premixture passageway.

The fuel nozzle, denoted by 20, according to the present embodiment includes a tapered portion 23, a flat portion 24, and a fuel passageway 25, as with the fuel nozzle 20 according to the first embodiment. The fuel nozzle 20 according to the present embodiment includes a first array of fuel injection holes 26a, a second array of fuel injection holes 26b, and a third array of fuel injection hole 26c that are defined in the fuel nozzle 20 so as to provide fluid communication between the fuel passageway 25 and the outside of the fuel nozzle 20.

The first array of fuel injection holes 26a, the second array of fuel injection holes 26b, and the third array of fuel injection hole 26c are spaced from each other in an axial direction Z of the fuel nozzle 20. The first array of fuel injection holes 26a is positioned most upstream, i.e., upstream of the second and third arrays of fuel injection holes 26b and 26c with respect to the direction in which the fuel or the air flows. The third array of fuel injection holes 26c is positioned most downstream, i.e., downstream of the first and second arrays of fuel injection holes 26a and 26b with respect to the direction in which the fuel or the air flows.

As illustrated in FIG. 9A, the fuel injection holes 26a of the first array are four fuel injection holes 26a disposed at equal intervals in the circumferential directions of the fuel nozzle 20. The four fuel injection holes 26a are disposed in a cross-sectional plane across the fuel nozzle 20 at respective angles of 45, 135, 225, and 315 degrees that are incremented clockwise around the fuel passageway 25 from a radial direction X of the premixture passageway 18. As illustrated in FIG. 9B, the fuel injection holes 26b of the second array are two fuel injection holes 26b disposed at equal intervals in the circumferential directions of the fuel nozzle 20. The two fuel injection holes 26b are disposed in a cross-sectional plane across the fuel nozzle 20 at respective angles of 0 and 180 degrees around the fuel passageway 25 from the radial direction X of the premixture passageway 18. In other words, the angles at which the fuel injection holes 26a of the first array are disposed around the fuel passageway 25 and the angles at which the fuel injection holes 26b of the second array are disposed around the fuel passageway 25 are shifted out of alignment with each other. As illustrated in FIG. 9C, the fuel injection hole 26c of the third array is a single fuel injection hole 26c disposed at an angle of 0 degrees around the fuel passageway 25 from the radial direction X of the premixture passageway 18.

The fuel injection hole 26c of the third array is defined in the flat portion 24 of the fuel nozzle 20. According to the most important feature of the present embodiment, the fuel injection holes 26a of the first array and the fuel injection hole 26b of the second array are defined in the tapered portion 23 of the fuel nozzle 20 and are positioned downstream of the opening 22 in the outer circumferential partition member 17 along the axial direction Z of the premixture passageway 18.

The fuel nozzle 20 according to the present embodiment is capable of uniformizing a distribution of fuel concentrations to reduce NOx emissions as with the case of the first embodiment. In addition, the fuel nozzle 20 is able to prevent internal flame stabilization and flame backflow that tend to occur in the presence of regions where a high fuel concentration prevails in the premixture passageway 18.

According to the present embodiment, the single fuel injection hole 26c of the third array, i.e., the final array, is disposed in a position that is asymmetrical with respect to a reference line Y passing through the radial center of the fuel nozzle 20 perpendicularly to the radial direction X of the premixture passageway 18. The single fuel injection hole 26c thus arranged is capable of dealing with a nonuniform concentration distribution, brought about by air streams, of the fuel ejected from the fuel injection holes 26a and 26b of the first and second arrays. Specifically, the different numbers of the fuel injection hole 26c on the radially outer and inner sides of the premixture passageway 18 are effective to uniformize a distribution of fuel concentrations.

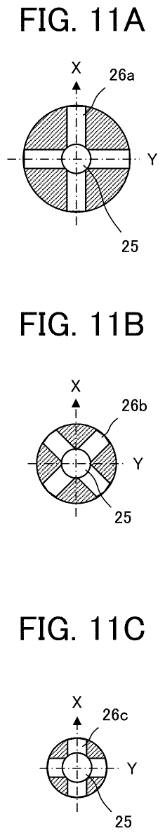

According to the second embodiment, the fuel injection holes 26a of the first array are four fuel injection holes 26a, whereas the fuel injection holes 26b of the second array are two fuel injection holes 26b and the fuel injection hole 26c of the third array is a single injection hole 26c. However, the present invention is not limited to the second embodiment as to the numbers of fuel injection holes of first, second, and third arrays. According to a third modification of the present invention as illustrated in FIGS. 11A through 11C corresponding to FIGS. 9A through 9C, for example, the four fuel injection holes 26a of the first array are disposed in a cross-sectional plane across the fuel nozzle 20 at respective angles of 0, 90, 180, and 270 degrees around the fuel passageway 25 from the radial direction X of the premixture passageway 18, as illustrated in FIG. 11A. The fuel injection holes 26b of the second array are four fuel injection holes 26b disposed at equal intervals in the circumferential directions of the fuel nozzle 20. The four fuel injection holes 26b are disposed in a cross-sectional plane across the fuel nozzle 20 at respective angles of 45, 135, 225, and 315 degrees around the fuel passageway 25 from the radial direction X of the premixture passageway 18, as illustrated in FIG. 11B. The fuel injection holes 26c of the third array are four fuel injection holes 26c disposed at equal intervals in the circumferential directions of the fuel nozzle 20. The four fuel injection holes 26c are disposed in a cross-sectional plane across the fuel nozzle 20 at respective angles of 0, 90, 180, and 270 degrees around the fuel passageway 25 from the radial direction X of the premixture passageway 18, as illustrated in FIG. 11C.

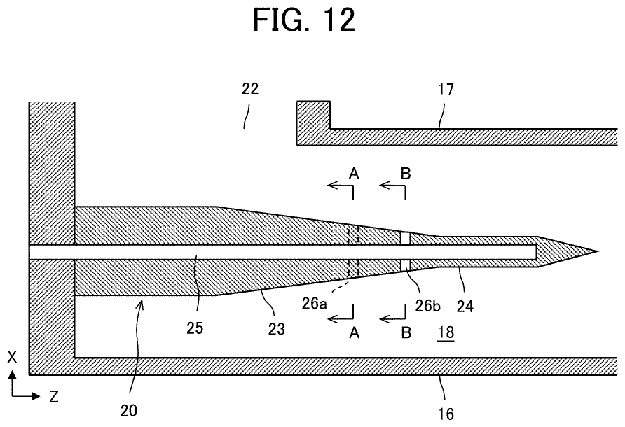

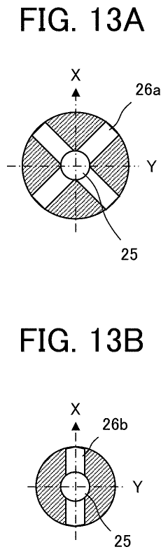

According to the first embodiment, as described above, the fuel injection holes 26a of the first array are defined in the tapered portion 23 of the fuel nozzle 20, and the fuel injection holes 26b of the second array are defined in the flat portion 24 of the fuel nozzle 20. According to the second embodiment, as described above, the fuel injection holes 26a and 26b of the first and second array are defined in the tapered portion 23, and the fuel injection hole 26c of the third array is defined in the flat portion 24 of the fuel nozzle 20. However, the present invention is not limited to the first and second embodiments as to the positions of the fuel injection holes. According to a fourth modification illustrated in FIGS. 12, 13A, and 13B, for example, two arrays of fuel injection holes 26a and 26b are defined in the tapered portion 23 of the fuel nozzle 20, and no fuel injection hole or holes are defined in the flat portion 24 of the fuel nozzle 20.

Although the preferred embodiments and modifications of the present invention have been described above, it will be obvious to those skilled in the art that many changes and modifications can be made therein without departing from the scope of the appended claims.

### DESCRIPTION OF REFERENCE CHARACTERS

3: Combustor
6: Main burner
10: Air passageway
11: Combustion chamber
16: Inner circumferential partition member
17: Outer circumferential partition member
18: Premixture passageway
19: Main fuel system
20: Fuel nozzle
22: Opening
23: Tapered portion
24: Flat portion
25: Fuel passageway
26a, 26b, 26c: Fuel injection hole

What is claimed is:

1. A gas turbine combustor comprising:
a premixture combustion burner; and
a combustion chamber for burning a fuel and air supplied from the premixture combustion burner,
the premixture combustion burner including a fuel nozzle for injecting a fuel supplied from a fuel system and a premixture passageway for mixing the fuel injected from the fuel nozzle and air supplied from an air passageway and supplying an air-fuel mixture to the combustion chamber, wherein
the fuel nozzle includes
a tapered portion whose outside diameter is progressively reduced from a proximal side to a distal side of the fuel nozzle,
a flat portion extending from the tapered portion toward the distal side of the fuel nozzle and having a uniform outside diameter from the proximal side to the distal side of the fuel nozzle,
a fuel passageway defined in the fuel nozzle and extending in an axial direction of the fuel nozzle, and
a plurality of arrays of fuel injection holes defined in the fuel nozzle to provide fluid communication between the fuel passageway and an outside of the fuel nozzle, each array including at least one fuel injection hole, the arrays being spaced from each other in the axial direction of the fuel nozzle, and
the arrays of fuel injection holes include at least one array of fuel injection holes defined in the tapered portion.

2. The gas turbine combustor according to claim 1, wherein
the arrays of fuel injection holes include at least one array of fuel injection holes defined in the flat portion.

3. The gas turbine combustor according to claim 1, wherein
the arrays of fuel injection holes include two arrays of fuel injection holes defined in the tapered portion and a single array of fuel injection holes defined in the flat portion.

4. The gas turbine combustor according to claim 1, wherein
the premixture passageway is defined between an inner circumferential partition member and an outer circumferential partition member and supplied with air from the air passageway through an opening defined in the outer circumferential partition member, and
the arrays of fuel injection holes include a first array of fuel injection holes positioned most upstream and defined in the tapered portion, the first array of fuel injection holes lying in a same position as or downstream of the opening defined in the outer circumferential partition member in an axial direction of the premixture passageway.

5. The gas turbine combustor according to claim 1, wherein
the arrays of fuel injection holes include a final array of fuel injection holes positioned most downstream, the final array of fuel injection holes are one or more fuel injection holes that are asymmetrical with respect to a reference line passing through a radial center of the fuel nozzle perpendicularly to a radial direction of the premixture passageway.
